(19) United States
(12) Patent Application Publication
(10) Pub. No.: US 2021/0016612 A1
(43) Pub. Date: Jan. 21, 2021

(54) HEAVY GOODS VEHICLE PNEUMATIC TIRE PROVIDED WITH A RADIOFREQUENCY COMMUNICATION MODULE

(71) Applicant: COMPAGNIE GENERALE DES ETABLISSEMENTS MICHELIN, Clermont-Ferrand (FR)

(72) Inventors: PATRICK DAYET, Clermont-Ferrand (FR); JULIEN DESTRAVES, Clermont-Ferrand (FR); EMMANUEL JOULIN, Clermont-Ferrand (FR); JEAN-LOUIS MARCHAL, Clermont-Ferrand (FR)

(21) Appl. No.: 16/982,283

(22) PCT Filed: Mar. 18, 2019
(86) PCT No.: PCT/FR2019/050599

§ 371 Date: Sep. 18, 2020

(30) Foreign Application Priority Data
Mar. 20, 2018 (FR) 1852350

(51) Int. Cl. B60C 23/04; B60C 19/00; B60C 15/00; B60C 15/06

(52) U.S. Cl. CPC B60C 23/0452; B60C 19/00; B60C 15/0009; B60C 15/0603; B60C 23/0479; B60C 2015/0621; B60C 2200/06; B60C 2015/009; B60C 2015/061; B60C 2015/0614; B60C 23/0493

(57) ABSTRACT

A heavy goods vehicle tire has a radial carcass reinforcement, made up of a single layer of metal reinforcing elements anchored in each of the beads by a turn-up around a bead wire. The turn-up of the carcass reinforcement layer and the main part of the carcass reinforcement layer are coupled, and a radiofrequency communication module is placed in the coupling region at the interface between the turn-up of the carcass reinforcement layer and axially outwardly adjacent layer of rubber compound.

### FIELD OF THE INVENTION

The present invention relates to tyres, and more particularly to a tyre equipped with a radiofrequency communication module.

### PRIOR ART

A tyre of the heavy goods vehicle type, equipped with a radiofrequency communication module is already known from the prior art, notably from EP 1 977 912 B1. In that document, the radiofrequency communication module comprises a passive radiofrequency identification transponder equipped with a helical radiating antenna forming a dipole. This type of transponder is generally known by the acronym RFID. Such a transponder is able to store data, for example relating to the identity, to the type and/or to the date of manufacture of the tyre.

The tyre described in EP 1 977 912 B1, as illustrated in FIGS. 1 to 3, is intended to be mounted on a drop-centre rim (15° drop centre). This tyre comprises a radial carcass reinforcement, made up of a single carcass reinforcement layer formed of reinforcing elements inserted between two skim layers of rubber compound, a crown reinforcement, itself radially capped by a tread, the tread being connected to two beads by two sidewalls. The layer of reinforcing elements of the carcass reinforcement is anchored in each of the beads by being turned up around a bead wire to form a main part of the carcass reinforcement layer, extending from one bead wire to the other, and a turn-up of the carcass reinforcement layer in each of the beads. The turn-up of the carcass reinforcement layer is separated from the main part of the carcass reinforcement layer by a first layer of rubber compound extending radially from the bead wire to beyond the end of the turn-up of the carcass reinforcement layer, and the turn-up of the carcass reinforcement layer extends axially towards the outside in contact with a second layer of rubber compound, itself at least in contact with a third layer of rubber compound that forms the exterior surface of the tyre in the region of the bead, the third layer of rubber compound notably being intended to come into contact with the rim. The third layer of rubber compound is, radially towards the outside, in contact with a fourth layer of rubber compound that forms the exterior surface of a sidewall. This tyre is such that, in meridian section:
the distance between the end of the turn-up of the carcass reinforcement layer and the radially innermost point of the circle circumscribed on the bead wire is of the order of 30% of the distance between the axially outermost point of the main part of the carcass reinforcement layer and the radially innermost point of the circle circumscribed on the bead wire, and
the radiofrequency communication module is positioned in the bead at the interface between the first and second layer of rubber compound and radially between the end of the turn-up of the carcass ply and the radially outer end of the first layer of rubber compound.

This document specifies that this position allows optimal transmission of the data recorded in the radiofrequency communication module, notably by preventing part of the communication module from extending into that volume of the bead that is comprised radially between the end of the turn-up and the bead wire.

### BRIEF DESCRIPTION OF THE INVENTION

The subject of the invention is a similar tyre in which, in meridian section:
the distance between the end of the turn-up of the carcass reinforcement layer and the radially innermost point A of the circle circumscribed on the bead wire is between 45 and 90% of the distance between the axially outermost point E of the main part of the carcass reinforcement layer and the radially innermost point A of the circle circumscribed on the bead wire,
the turn-up of the carcass reinforcement layer and the main part of the carcass reinforcement layer are the only layers of reinforcing elements of which the elongation at break is less than 6% that are present in a sidewall region making up at least 90% of the region comprised between the end of the turn-up of the carcass reinforcement layer and the radially outermost point B of the bead wire, and
the radiofrequency communication module is positioned in the bead at the interface between the turn-up of the carcass reinforcement layer and the second layer of rubber compound.

The Applicant Company has observed that this positioning of the radiofrequency communication module in the immediate vicinity of the metal reinforcing threads allows, in spite of this proximity, satisfactory radiofrequency communication with an external reader.

This position also has the advantage of being highly favourable for the fitting of the communication module during the manufacture of the tyre. Specifically, the communication module is positioned on the turn-up of the carcass reinforcement layer, which is mechanically stable, affording quality orientation of the communication module within the tyre. Further, the communication module is embedded within the structure of the tyre, thus guarding it against potential attacks coming from the outside, such as knocks from kerbing. In addition, the positioning at the interface between the second layer of rubber compound and the turn-up of the carcass reinforcement layer allows the communication module to be sufficiently distanced from the end of the turn-up of the carcass reinforcement layer, which constitutes a stiffness singularity within the architecture of the tyre. This distancing is beneficial for the endurance of the tyre. Finally, this positioning of the communication module may allow all or part of the assembly made up of the second, third and fourth layers of rubber compound to be co-extruded, thus affording a not insignificant gain in productivity in the building of a green tyre.

Within the meaning of the invention, a drop-centre rim (15° drop centre) or safety-hump rim is a one-piece rim, as defined in the ETRTO, of which the seats that are intended to receive the beads of the tyre have a frustoconical shape, the angle formed with the axial direction being substantially equivalent to 15°. These seats are also extended by rim flanges of reduced height compared with flanges of flat-base rims, the rim seats of which have substantially cylindrical forms.

The position of the axially outermost point E of the main part of the carcass reinforcement is determined on a tyre that has been fitted and inflated under nominal conditions. This determination can be carried out for example using a tomographic technique.

The positions of the radially innermost point A and radially outermost point B of the circle circumscribed on the bead wire can also be determined using a tomographic technique or else are determined on a section of a tyre, the spacing of the beads of which is the same as when the tyre is fitted on the mounting rim recommended by the ETRTO, said tyre thus being neither fitted nor inflated.

The distance between the axially outermost point of the main part of the carcass reinforcement layer and the radially innermost point A of the circle circumscribed on the bead wire is measured on a tyre fitted and inflated under nominal conditions. This measurement can be carried out for example using a tomographic technique.

The other distances, which are notably measured from the radially innermost point A of the circle circumscribed on the bead wire, can also be measured using a tomographic technique or else are measured on a section of a tyre, the spacing of the beads of which is the same as when the tyre is fitted on the mounting rim recommended by the ETRTO, said tyre thus being neither fitted nor inflated.

What is understood here by “axially towards the outside” is that something is situated towards the outside of the tyre in comparison with the main part of the carcass reinforcement layer in a direction parallel to the natural axis of rotation of the tyre.

In this instance, the first layer of rubber compound is a filling compound that fills the space delimited by the main part of the carcass reinforcement layer and the turn-up of the carcass reinforcement layer, and referred to as the “bead filler”.

The second layer of rubber compound is a padding element used to ensure the geometry of the turn-up of the carcass reinforcement layer, notably in the regions of coupling and decoupling between the main part and the turn-up of the carcass reinforcement layer.

Finally, the third layer of rubber compound is a protective rubber providing contact between the tyre and the wheel during fitting.

Advantageously, with the first layer of rubber compound being profiled, the turn-up of the carcass reinforcement layer and the main part of the carcass reinforcement layer are coupled radially towards the outside starting from a point C on the turn-up of the carcass reinforcement layer, which point is situated at a distance between 30 and 55% of the distance between the end of the turn-up of the carcass reinforcement layer and the radially innermost point A of the circle circumscribed on the bead wire, and the radiofrequency communication module is positioned radially on the outside beyond the point C.

This positioning of the communication module radially on the outside of the point C allows the communication module to be kept away from the region of maximum bending of the bead, which lies between the radially upper end of the bead wire, the point B, and the region of coupling delimited by the point C. As a result, the mechanical stress loadings experienced by the communication module are not as high, thanks to its being positioned radially beyond the point C. In addition, the first layer of rubber compound is profiled in order to provide coupling and decoupling between the turn-up of the carcass reinforcement layer and the main part of the carcass reinforcement layer. As a result, the turn-up of the carcass reinforcement layer, which is small in thickness by nature, follows this profiled element, allowing the communication module to be easily positioned radially with respect to the singular points of this profiled element. Thus, the precision with which the communication module is laid on the turn-up of the carcass reinforcement layer is improved by the proximity of the points of reference that the singular points of the profile of the first layer of rubber compound constitute. It is thus easy to identify point C for positioning the communication module radially on the outside thereof when the green tyre is being built.

According to one preferred embodiment, radially towards the outside, starting from the point C of the turn-up of the carcass reinforcement layer, the turn-up of the carcass reinforcement layer and the main part of the carcass reinforcement layer are coupled along a length of between 15 and 65% of the distance between the end of the turn-up of the carcass reinforcement layer and the radially innermost point A of the circle circumscribed on the bead wire, and are then decoupled by the first layer of rubber compound as far as the end of the turn-up of the carcass reinforcement layer, and the radiofrequency communication module is placed radially facing this region of coupling and the radiofrequency communication module is placed radially facing this region of coupling between the turn-up and the main part of the carcass reinforcement.

This positioning of the communication module is ideal as it keeps the communication module away both from the region of maximum bending of the bead and from the end of the turn-up of the carcass reinforcement layer. Thus, the presence of the communication module has no effect on the endurance of the tyre while also preserving the physical integrity of the communication module while ensuring good radiocommunication performance. Finally, it is particularly easy to identify this region of coupling when building the green tyre to position the communication module.

According to one preferred embodiment, the decoupling length is comprise between 5 and 40% of the distance between the end of the turn-up of the carcass reinforcement layer and the radially innermost point A of the circle circumscribed on the bead wire and is preferably between 15 and 35% of said distance between the end of the turn-up of the carcass reinforcement layer and the radially innermost point A of the circle circumscribed on the bead wire.

Preferably according to the invention, the turn-up of the carcass reinforcement layer and the main part of the carcass reinforcement layer are coupled along a length of between 25 and 40% of the distance between the end of the turn-up of the carcass reinforcement layer and the radially innermost point A of the circle circumscribed on the bead wire.

Within the meaning of the invention, the main part of the carcass reinforcement layer and the turn-up of the carcass reinforcement layer are said to be coupled if the respective reinforcing elements of the main part of the carcass reinforcement layer and of the turn-up of the carcass reinforcement layer are separated by a thickness of rubber compound that is substantially constant and at most 5 mm along a length greater than 15% of the distance between the end of the turn-up of the carcass reinforcement layer and the radially innermost point A of the circle circumscribed on the bead wire. The thickness of rubber compound separating the respective reinforcing elements of the main part of the carcass reinforcement layer and of the turn-up of the carcass reinforcement layer is measured in the direction normal to the reinforcing elements of the main part of the carcass reinforcement layer. Advantageously according to the invention, the respective reinforcing elements of the main part of the carcass reinforcement layer and of the turn-up of the carcass reinforcement layer are separated by a substantially constant thickness of rubber compound of at most 3.5 mm, and preferably, they are separated by a substantially constant thickness of rubber compound of at least 0.8 mm and, more preferably still, by a substantially constant thickness of rubber compound of at least 2.5 mm.

Within the meaning of the invention, a substantially constant thickness of rubber compound separating the respective reinforcing elements of the main part of the carcass reinforcement layer and of the turn-up of the carcass reinforcement layer is a thickness which does not vary by more than 0.5 mm. The variations in thickness are thus due only to the phenomena of flow during the manufacture and curing of the tyre.

Within the meaning of the invention, the first layer of rubber compound can be made up of several rubber compounds, of which the stiffness properties, and more specifically the tensile elastic modulus values at 10% elongation, can vary. In the case of several rubber compounds making up the first layer, they advantageously form a stiffness gradient that decreases from the bead wire towards the radially outer end of said first layer.

According to one preferred embodiment of the invention, with the crown reinforcement comprising at least one layer of reinforcing elements, the ratio of the radial distance between the axially outermost point of the main part of the carcass reinforcement layer and the radially outermost point of the nominal rim, that is to say the radially outermost point of the rim flange, to the radial distance between the axially outer end of the layer of reinforcing elements of the axially widest crown reinforcement and the radially outermost point of the nominal rim is less than or equal to 55%.

The radial distance between the axially outermost point of the main part of the carcass reinforcement layer and the radially outermost point of the nominal rim is measured on a tyre fitted and inflated under nominal conditions. This measurement can be carried out for example using a tomographic technique.

The radial distance between the axially outer end of the layer of reinforcing elements of the axially widest crown reinforcement and the radially outermost point of the nominal rim can also be measured using a tomographic technique, the tyre being fitted and inflated under nominal conditions.

Preferably also according to the invention, the ratio of the radial distance between the axially outermost point E of the main part of the carcass reinforcement layer and the radially outermost point of the nominal rim, to the radial distance between the axially outer end of the layer of reinforcing elements of the axially widest crown reinforcement and the radially outermost point of the nominal rim is less than 53%.

Tests have shown that the tyres thus produced according to the invention, the mass of which is less than that of tyres of more conventional design, for example having additional layers of reinforcing elements of the stiffener type, have a performance in terms of endurance, and notably in terms of endurance in the bead regions, at least as good as, or even better than, those of said tyres of more conventional design.

Advantageously according to the invention, the radially inner end of the second layer of rubber compound is radially comprised between the radially outermost point of the circle circumscribed on the bead wire and the radially innermost point of the circle circumscribed on the bead wire. This positioning is determined on a section of a tyre, the spacing of the beads of which is the same as when the tyre is fitted on the mounting rim recommended by the ETRTO, said tyre therefore being neither fitted nor inflated.

According to one preferred embodiment of the invention, the tensile elastic modulus at 10% elongation of the skim layers of the carcass reinforcement layer is between 4 and 16 MPa and preferably between 8 and 12 MPa. These values make it possible notably to define the desired compromise between the performance in terms of endurance of the tyre and the performance in terms of rolling resistance thereof.

Preferably according to the invention, the tensile elastic modulus at 10% elongation of the first layer of rubber compound is less than or equal to the tensile elastic modulus at 10% elongation of the skim rubber of the carcass reinforcement layer. This choice makes it possible notably to concentrate the shear forces within the first layer of rubber compound.

Also preferably according to the invention, the tensile elastic modulus at 10% elongation of the first layer of rubber compound is greater than 50% of the tensile elastic modulus at 10% elongation of the skim rubber of the carcass reinforcement layer and preferably is greater than 70% of the tensile elastic modulus at 10% elongation of the skim rubber of the carcass reinforcement layer. This choice makes it possible to keep the shear forces within the first layer of rubber compound while ensuring good performance in terms of endurance.

Advantageously according to the invention, the tensile elastic modulus at 10% elongation of the second layer of rubber compound is less than 150% of the tensile elastic modulus at 10% elongation of the skim rubber of the carcass reinforcement layer. According to this advantageous embodiment of the invention, the second layer of rubber compound confers sufficient stiffness to ensure good endurance of the tyre when pressure is applied to the rim flanges while ensuring satisfactory performance in terms of rolling resistance.

According to one preferred embodiment of the invention, in order to favour the compromise between the performance in terms of endurance and the performance in terms of rolling resistance, the tensile elastic modulus at 10% elongation of the first layer of rubber compound is greater than or equal to the tensile elastic modulus at 10% elongation of the third layer of rubber compound, which is itself greater than or equal to the tensile elastic modulus at 10% elongation of the fourth layer of rubber compound.

Within the meaning of the invention, the main part of the carcass reinforcement layer and the turn-up of the carcass reinforcement layer are said to be decoupled if, radially on the outside of the coupling region, the thickness of rubber compound separating the respective reinforcing elements of the main part of the carcass reinforcement layer and of the turn-up of the carcass reinforcement layer is greater than that of the coupling region. The respective reinforcing elements of the main part of the carcass reinforcement layer and of the turn-up of the carcass reinforcement layer are thus advantageously separated by a thickness of rubber compound of between 3 and 8 mm, said thickness of rubber compound being measured in the direction normal to the reinforcing elements of the main part of the carcass reinforcement layer between the respective reinforcing elements of the layer the main part of the carcass reinforcement layer and of the turn-up of the carcass reinforcement layer. Preferably according to the invention, in the decoupled region, the respective reinforcing elements of the main part of the carcass reinforcement layer and of the turn-up of the carcass reinforcement layer are separated by at most 6 mm, and preferably they are separated by at least 4 mm.

According to an advantageous embodiment of the invention, the decoupling region can be made up of a first part, referred to as a transition part, extending the coupling region in which the thickness of rubber compound separating the respective reinforcing elements of the main part of the carcass reinforcement layer and of the turn-up of the carcass reinforcement layer increases and a second, radially outermost, part in which the thickness of rubber compound separating the respective reinforcing elements of the main part of the carcass reinforcement layer and of the turn-up of the carcass reinforcement layer is substantially constant.

According to this variant embodiment of the invention, the increase in the thickness of the first layer of rubber compound makes it possible to compensate for the reduction in the tension in the reinforcing elements of the carcass reinforcement towards the end of the turn-up thereof in order to absorb the shear stresses between the main part of the carcass reinforcement layer and the turn-up thereof.

Advantageously also, the decoupling length is between 5 and 40% of the distance between the end of the turn-up of the carcass reinforcement layer and the radially innermost point of the circle circumscribed on the bead wire and is preferably between 15 and 35% of the distance between the end of the turn-up of the carcass reinforcement layer and the radially innermost point of the circle circumscribed on the bead wire.

According to one preferred embodiment of the invention, in any meridian plane, along a length of the turn-up of the carcass reinforcement layer that is delimited radially between the end of said turn-up of the carcass reinforcement layer and a point situated at a distance from the radially innermost point of the circle circumscribed on the bead wire that is equal to 65% of the distance between the end of the turn-up of the carcass reinforcement layer and the radially innermost point of the circle circumscribed on the bead wire, every point of the turn-up of the carcass reinforcement layer is at distance from the exterior surface of the tyre of less than 10 mm. Further preferably, every point of the turn-up of the carcass reinforcement layer is at a distance from the exterior surface of the tyre of less than 10 mm along a length of the turn-up of the carcass reinforcement layer that is radially delimited between the end of said turn-up and a point situated at a distance from the radially innermost point of the circle circumscribed on the bead wire that is equal to 50% of the distance between the end of the turn-up of the carcass reinforcement layer and the radially innermost point of the circle circumscribed on the bead wire.

Advantageously too according to the invention, in any meridian plane, over a radial distance greater than 4 mm, and preferably greater than 10 mm, starting radially on the outside of the end of the turn-up of the carcass reinforcement layer and at a radial distance from the end of the turn-up of the carcass reinforcement layer that is equal to 2.5 times the diameter of a reinforcing element of the carcass reinforcement, and extending radially towards the outside, the thickness, measured in the direction normal to the reinforcing elements of the turn-up of the carcass reinforcement layer at the end of the turn-up of the carcass reinforcement layer, of the fourth layer of rubber compound forming the exterior surface of a sidewall is substantially constant.

Advantageously too according to the invention, in any meridian plane, over a radial distance greater than 4 mm, and preferably greater than 10 mm, starting radially on the inside of the end of the turn-up of the carcass reinforcement layer and at a radial distance from the end of the turn-up of the carcass reinforcement layer that is equal to 2.5 times the diameter of a reinforcing element of the carcass reinforcement, and extending radially towards the inside, the thickness, measured in the direction normal to the reinforcing elements of the turn-up of the carcass reinforcement layer at the end of the turn-up of the carcass reinforcement layer, of the fourth layer of rubber compound forming the exterior surface of a sidewall is substantially constant.

Within the meaning of the invention, the expression “a thickness that is substantially constant” means that it does not vary by more than 0.5 mm. These variations in thickness are due only to phenomena of flow during the manufacture and curing of the tyre.

The fourth layer of rubber compound thus produced according to the invention appears to contribute towards better positioning and application of the first layer of rubber compound in order to ensure the coupling and possibly the decoupling of the main part of the carcass reinforcement layer and of the turn-up of the carcass reinforcement layer.

According to one advantageous embodiment of the invention, in any meridian plane, in each bead, the tyre has a retention reinforcement surrounding the bead wire and a volume of rubber compound in direct contact with the bead wire.

Such a retention reinforcement makes it possible, during use of the tyre, to limit changes in shape of the bead wire and thus to maintain satisfactory performance, notably in terms of endurance. Specifically, the tyre according to the invention, the structure of which results in lightening thereof, could, in some cases of usage or types of running, result in a geometric change in the bead region which could potentially be harmful to the performance of the tyre in terms of endurance. The presence of a retention reinforcement as proposed makes it possible to delay or even prevent such a geometric change. Advantageously too according to the invention, the retention reinforcement consists of a layer of textile reinforcing elements of the aliphatic polyamide type.

Advantageously according to the invention, the bead wires are bead-wire bundles, that is to say bead wires formed from an assembly of rubberized threads wound around a form, preferably of hexagonal shape.

According to one embodiment of the invention, notably for further improving the performance in terms of endurance of the tyre, the carcass reinforcement is formed of cords, the structure of which is heavily penetrated with rubber compounds. These may for example be cords the construction of which increases the penetrability thereof with rubber compounds. They may also be cords into which rubber compounds are introduced during the manufacture of the cords themselves. They are then for example cords having at least two layers, at least one internal layer being sheathed with a layer consisting of a rubber composition which is not crosslinkable, is crosslinkable or is crosslinked, preferably based on at least one diene elastomer.

According to a variant embodiment of the invention, the crown reinforcement of the tyre is formed of at least two working crown layers of inextensible reinforcing elements, crossed from one layer to the other, forming, with the circumferential direction, angles of between 10° and 45°.

According to other variant embodiments of the invention, the crown reinforcement further comprises at least one layer of circumferential reinforcing elements.

One preferred embodiment of the invention also plans for the crown reinforcement to be supplemented radially on the outside by at least one additional layer, referred to as a protective layer, of reinforcing elements, referred to as elastic reinforcing elements, oriented relative to the circumferential direction with an angle of between 10° and 45° and in the same direction as the angle formed by the inextensible elements of the working layer radially adjacent to it.

The protective layer may have an axial width less than the axial width of the narrowest working layer. Said protective layer may also have an axial width greater than the axial width of the least wide working layer, such that it covers the edges of the least wide working layer and, if the radially uppermost layer is the least wide layer, such that it is coupled, in the axial extension of the additional reinforcement, to the widest working crown layer over an axial width, and is then decoupled in an axially outer position from said widest working layer by profiled elements with a thickness of at least 2 mm. In the aforementioned case, the protective layer formed by elastic reinforcing elements may, on the one hand, be decoupled if required from the edges of said least wide working layer by profiled elements with a thickness substantially less than the thickness of the profiled elements separating the edges of the two working layers, and, on the other hand, have an axial width less than or greater than the axial width of the widest crown layer.

According to any one of the embodiments of the invention mentioned above, the crown reinforcement may be further supplemented, radially on the inside between the carcass reinforcement and the radially inner working layer closest to said carcass reinforcement, by a triangulation layer made of inextensible steel metal reinforcing elements that form with the circumferential direction an angle of greater than 60° and in the same direction as that of the angle formed by the reinforcing elements of the radially closest layer of the carcass reinforcement.

Preferably, the communication module consists of the radiofrequency transponder encapsulated in an electrically insulating encapsulating rubber mass. By way of example, the radiofrequency transponder may be sandwiched between two sheets of insulating encapsulating rubber.

Advantageously, the elastic modulus of the encapsulating rubber mass is lower than or equal to the elastic modulus of the adjacent rubber compounds. This limits the forces at the interfaces between the communication module and the adjacent rubber compounds.

Likewise, advantageously, the relative dielectric constant of the encapsulating rubber mass is lower than the relative dielectric constant of the adjacent rubber compounds, and this facilitates radiofrequency communication between the module and an external reader.

Preferably, with the transponder comprising an electronic chip coupled to a radiating antenna defining a first longitudinal axis, this first longitudinal axis is oriented circumferentially.

This orientation is perpendicular to the threads of the carcass ply and is very favourable in terms of the mechanical integrity of the transponder and in terms of the quality of reading of the transducer.

According to a first embodiment of the communication module, with the radiating antenna comprising two helical antenna segments, the electronic chip is galvanically connected to the two helical antenna segments.

According to a second embodiment of the communication module, the radiofrequency transponder of the communication module additionally comprises a primary antenna electrically connected to the electronic chip, the primary antenna is inductively coupled to the radiating antenna, and the radiating antenna is a dipole antenna consisting of a single-strand helical spring defining the first longitudinal axis.

The primary antenna may be a coil having at least one turn defining a second longitudinal axis that is circumscribed in a cylinder the axis of revolution of which is parallel to the second longitudinal axis and the diameter of which is between one third and three times, and preferably between half and two times, the average diameter of the helical spring of the radiating antenna.

According to a highly preferred embodiment, the primary antenna is placed in the interior of the single-strand helical spring of the radiating antenna.

### DESCRIPTION OF THE FIGURES

The various subjects of the invention will be better understood by means of the following detailed description and the attached drawings, in which the same reference numbers are used throughout to reference parts which are identical, and in which:

FIG. 1 depicts a meridian view of a diagram of a tyre according to one embodiment of the invention;

FIG. 2 is an enlarged schematic depiction of the bead region of the tyre of FIG. 1;

FIG. 3 depicts a typical radiofrequency transponder;

FIG. 4 is a schematic exploded view of a communication module;

FIG. 5 is a perspective view of a radiofrequency transponder according to one embodiment of the invention in a configuration in which the electronic portion is located inside the radiating antenna;

FIG. 6 is a perspective view of a radiofrequency transponder according to the invention in a configuration in which the electronic portion is located outside of the radiating antenna; and

FIG. 7 is a perspective view of the electronic portion of a radiofrequency transponder in a configuration in which the electronic portion is located inside the radiating antenna.

In order to make them easier to understand, the figures are not shown to scale.

### DETAILED DESCRIPTION OF THE INVENTION

In what follows, the terms “rubber compound”, “rubber” and “compound” are used interchangeably to identify rubber constituents of a tyre.

Cords are said to be inextensible when said cords exhibit, under a tensile force equal to 10% of the breaking force, a relative elongation at most equal to 0.2%.

Cords are said to be elastic when said cords exhibit, under a tensile force equal to the breaking load, a relative elongation at least equal to 3% with a maximum tangent modulus of less than 150 GPa.

Circumferential reinforcing elements are reinforcing elements that make with the circumferential direction angles in the range +2.5°, −2.5° around 0°.

The circumferential direction of the tyre, or longitudinal direction, is the direction that corresponds to the periphery of the tyre and is defined by the direction in which the tyre runs.

The transverse or axial direction of the tyre is parallel to the axis of rotation of the tyre.

The radial direction is a direction intersecting the axis of rotation of the tyre and perpendicular thereto.

The axis of rotation of the tyre is the axis about which it turns in normal use.

A radial or meridian plane is a plane which contains the axis of rotation of the tyre.

The circumferential median plane, or equatorial plane, is a plane that is perpendicular to the axis of rotation of the tyre and divides the tyre into two halves.

For metal threads or cords, force at break (maximum load in N), breaking strength (in MPa), elongation at break (total elongation in %) and modulus (in GPa) are measured under tension in accordance with standard ISO 6892, 1984.

For rubber compositions, modulus measurements are taken under tension according to standard AFNOR-NFT-46002 of September 1988: the nominal secant modulus (or apparent stress, in MPa) at 10% elongation (normal temperature and relative humidity conditions according to standard AFNOR-NFT-40101 of December 1979) is measured in second elongation (i.e. after an accommodation cycle).

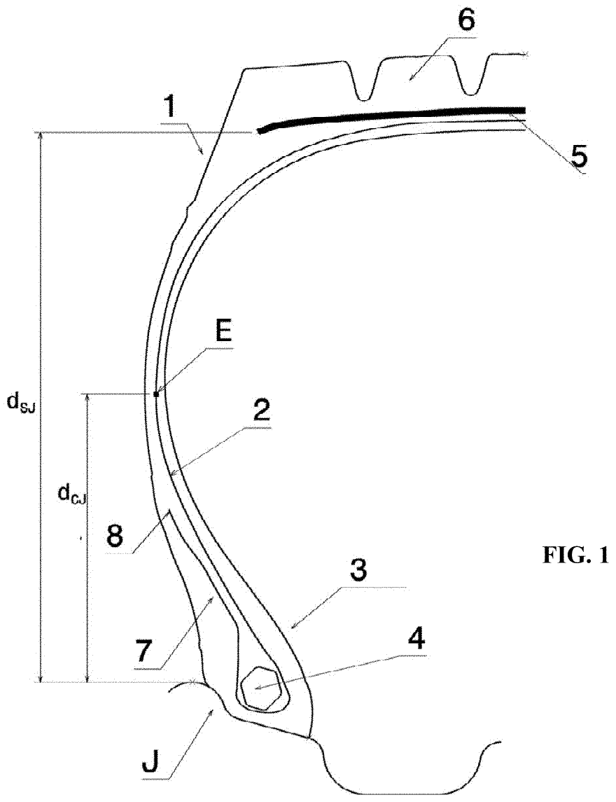

FIG. 1 depicts only a half-view of a tyre which extends symmetrically relative to the circumferential median plane, or equatorial plane, of a tyre.

In FIG. 1, the tyre 1 is of size 12 R 22.5. The tyre 1 comprises a radial carcass reinforcement 2 anchored in two beads 3. The carcass reinforcement 2 is hooped at the crown of the tyre by a crown reinforcement 5, itself capped by a tread 6.

The carcass reinforcement 2, formed by a single layer of metal cords, is wound, in each of the beads 3, around a bead wire 4 and forms, in each of the beads 3, a turn-up of the carcass reinforcement layer 7 having an end 8.

The carcass reinforcement 2 consists of reinforcing elements between two skim layers of which the tensile elastic modulus at 10% elongation is equal to 9.8 MPa.

The reinforcing elements of the carcass reinforcement 2 are 19.18 cords, of which the elongation at break is equal to 2.5%.

The cords of the carcass reinforcement of the tyre 1 are non-wrapped layered metal cords of 1+6+12 structure, consisting of a central nucleus formed of one thread, of an intermediate layer formed of six threads and of an outer layer formed of twelve threads.

FIG. 1 illustrates the tyre mounted on its nominal rim J; the axially outermost point E of the main part of the carcass reinforcement layer 2 is thus determined with the tyre inflated to its nominal pressure, for example by tomography.

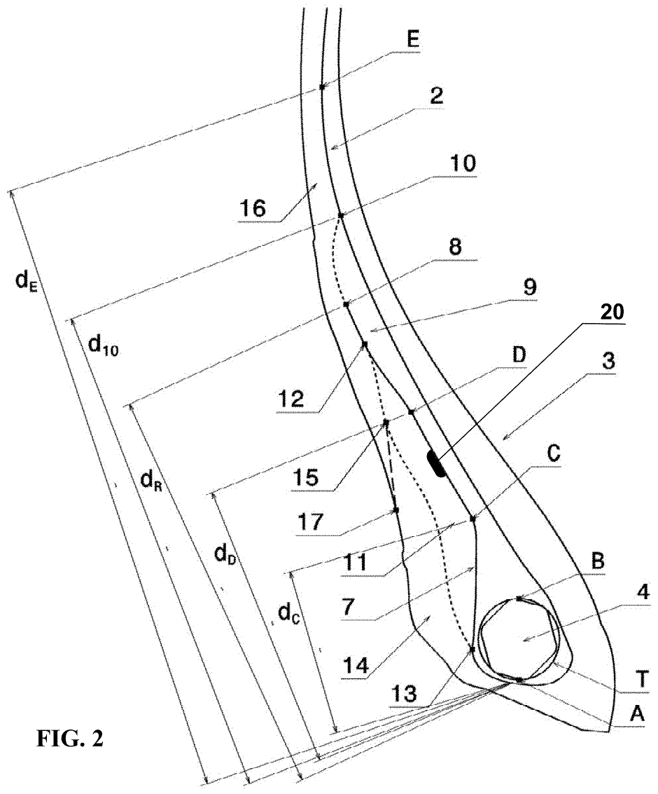

FIG. 2 illustrates, as an enlargement, a schematic cross-sectional depiction of a bead 3 of the tyre in which a part of the carcass reinforcement layer 2 is wound around a bead wire 4 in order to form a turn-up 7 having an end 8.

This FIG. 2 indicates the circle T circumscribed on the bead wire 4 and reveals the radially innermost point A of said circle T. This point A is defined in a radial cross section of the tyre, the spacing of the beads of which is the same as when the tyre is fitted on the mounting rim recommended by the ETRTO, said tyre not being fitted on a rim.

The radially outermost point B of the circle T is also determined.

The distance d_{E} between the point E and the point A is equal to 128 mm.

The distance d_{R} between the point 8 and the point A is equal to 90 mm.

The ratio of the distance d_{R} to the distance d_{E} is equal to 70% and is thus between 45 and 90%.

The radial distance d_{CJ} between the axially outermost point E of the main part of the carcass reinforcement layer and the radially outermost point of the nominal rim is equal to 108.2 mm.

The radial distance d_{SJ} between the axially outer end of the layer of reinforcing elements of the axially widest crown reinforcement and the radially outermost point of the nominal rim is equal to 206.7 mm.

The ratio of the distance d_{CJ} to the distance d_{SJ} is equal to 52.3% and is thus less than 53%.

The turn-up 7 of the carcass reinforcement layer is coupled to the main part of the carcass reinforcement layer 2 starting from the point C, such that the distance d_{C} between the point C and the point A is equal to 37 mm.

The ratio of the distance d_{C} to the distance d_{R} is equal to 41% and is thus between 30 and 55%.

The turn-up 7 of the carcass reinforcement layer is then decoupled from the main part of the carcass reinforcement layer 2 starting at the point D, such that the distance d_{D} between the point D and the point A is equal to 66 mm and such that the length of coupling between the point C and the point D is equal to 29 mm and is thus between 25 and 40% of the distance d_{R}. The coupling length is measured along the straight line passing through the points C and D.

The thickness of coupling between the main part of the carcass reinforcement layer 2 and the turn-up 7 of the carcass reinforcement layer, measured in the direction normal to the reinforcing elements of the main part of the carcass reinforcement layer 2 between the respective reinforcing elements of the main part of the carcass reinforcement layer and of the turn-up of the carcass reinforcement layer 2, is substantially constant and equal to 2.9 mm.

The decoupling length between the point D and the point 8 is equal to 21 mm and is thus between 15 and 35% of the distance d_{R}. The decoupling length is measured along the straight line passing through the points D and 8.

The turn-up 7 of the carcass reinforcement layer 2 is separated from the main part of the carcass reinforcement layer 2 by a first layer of rubber compound 9 having a radially outer end 10 at a distance d₁₀ from the point A equal to 117 mm. The first layer of rubber compound 9 has a tensile elastic modulus at 10% elongation equal to 7.8 MPa and thus less than the tensile elastic modulus at 10% elongation of the skim layers of the carcass reinforcement 2.

The first layer of rubber compound 9 is profiled in order to bear against the bead wire 4 and ensure the coupling and decoupling between the turn-up of the carcass reinforcement layer 7 and the main part of the carcass reinforcement layer 2.

Shown axially on the outside of the turn-up 7 of the carcass reinforcement layer is the second layer of rubber compound 11, the radially outer end 12 of which is radially on the inside of the end 8 of the turn-up 7 of the carcass reinforcement layer. According to another embodiment which has not been depicted, the radially outer end of the second layer of rubber compound is radially on the outside of the end 8 of the turn-up 7 of the carcass reinforcement layer.

The radially inner end 13 of the second layer of rubber compound 11 is radially comprised between the points A and B, which are the radially innermost and radially outermost points, respectively, of the circle circumscribed on the bead wire.

The second layer of rubber compound 11 has a tensile elastic modulus at 10% elongation equal to 12.5 MPa and thus greater than the tensile elastic modulus at 10% elongation of the skim layers of the carcass reinforcement 2.

In contact with the second layer of rubber compound 11 and radially under the bead wire, there is the third layer of polymer compound 14, the axially outermost end 15 of which is radially on the inside of the end 12 of the second layer of rubber compound 11.

The third layer of rubber compound 14 has a tensile elastic modulus at 10% elongation equal to 7.1 MPa.

Axially in contact with the first layer of rubber compound 9, with the second layer of rubber compound 11, and with the third layer of rubber compound 14, there is the fourth layer of rubber compound 16. The radially inner end 17 of the fourth layer of rubber compound 16 is radially on the inside of the end 15 of the third layer of rubber compound 14.

The fourth layer of rubber compound 16 has a tensile elastic modulus at 10% elongation equal to 3.1 MPa.

In regions situated on either side of the end 8 of the turn-up 7 of the carcass reinforcement layer, the profile of the fourth layer of rubber compound 16 is such that said fourth layer of rubber compound 16 has a thickness, measured in the direction normal to the reinforcing elements of the carcass reinforcement 2 at the end 8 of the turn-up 7, that is substantially constant and equal to 3.3 mm, along two radial lengths of around 5 mm from each of the two points situated on either side of the end 8 at distances from said end 8 equal to 2.5 mm, corresponding to more than 2.5 times the diameter of the carcass reinforcement cords, said diameter being 0.9 mm.

The bead 3 also comprises a radiofrequency communication module 20 arranged axially at the interface between the carcass reinforcement turn-up 7 and the second layer of rubber compound 11. This communication module 20 is positioned radially at the region of coupling between the main part 2 of the carcass reinforcement and the turn-up 7 of this carcass reinforcement, namely between the two points C and D in FIG. 2. This position affords the radiofrequency transponder of the communication module good mechanical protection and the Applicant Company has found experimentally that the nearby presence of the metal threads of the turn-up 7 of the carcass reinforcement 2 did not prevent good communication with an external reader. The communication module 20 is preferably placed substantially in the middle of the coupling region, between C and D. As indicated in FIG. 2, the communication module is placed in the tyre in such a way that its radiofrequency antenna of the dipole type is positioned circumferentially. Thus, the radiofrequency antenna is perpendicular to the reinforcing elements of the radial-type carcass reinforcing layer. Thus, the radiofrequency antenna then rests on a large number of reinforcing elements, and this improves its mechanical stability. In addition, despite the fact that the reinforcing elements may be metallic, the relative perpendicularity of the orientation of the radiofrequency antenna with respect to the metallic reinforcing elements only minimally disrupts the radiofrequency operation of the antenna.

FIG. 4 is a exploded view of a communication module 20. This module 20 comprises a radiofrequency transponder 30 embedded between two layers 22a and 22b of a non-vulcanized electrically insulating rubber compound. The thickness of each layer is of the order of 1 mm, the length of the order of 50 to 70 mm and its width of the order of 10 to 20 mm. Such a communication module is a semi-finished product that can be incorporated into the structure of the tyre 1 during the manufacture of the latter.

The chosen position at which to site the communication module 20 is particularly favourable. The non-vulcanized semi-finished product is laid on the surface of the turn-up 7 of the carcass reinforcement 2 during the building of the tyre before the laying of a complex combining the second, third and fourth layers of rubber compound.

The rubber compound 22 for encapsulating the radiofrequency transponder 30 contains 100 phr (parts by weight per 100 parts of rubber) of a polymer such as EPDM (ethylene propylene diene monomer rubber), butyl rubber, neoprene or a diene elastomer such as SBR (styrene-butadiene rubber), polybutadiene, natural rubber or polyisoprene.

The compound may contain fillers such as silica, carbon black, chalk and kaolin fillers:
with a silica filler in a maximum amount of 50 phr;
with a carbon black filler of ASTM grade higher than 700, in an amount lower than 50 phr;
with a carbon black filler of grade lower than or equal to 500, in a maximum amount of 20 phr.
It is possible to add or replace these fillers with chalk or kaolin.

Such amounts and types of fillers make it possible to guarantee a relative permittivity lower than 6.5, in particular at a frequency of 915 MHz.

The stiffness in the cured state of the encapsulating compound is preferably lower than or close to those of the adjacent rubber compounds.

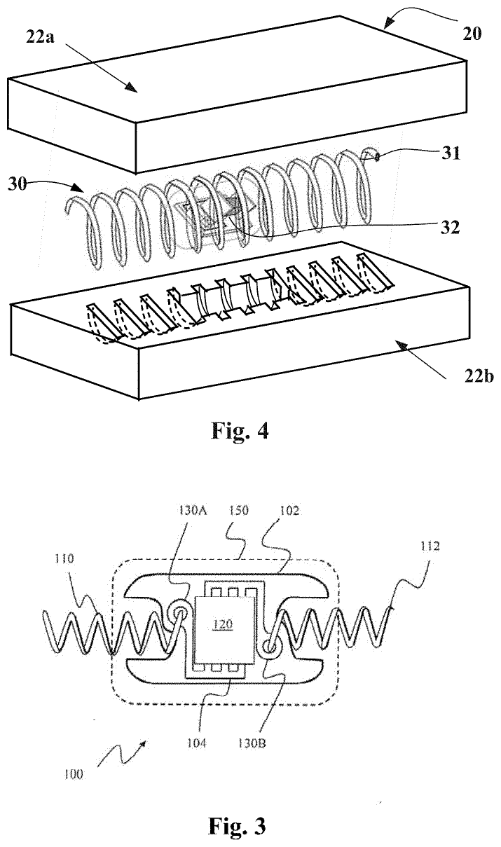

In a first embodiment, the radiofrequency transponder of the communication module 20 is a conventional radiofrequency transponder, such as depicted in FIG. 3 and described in document WO 2012/030321 A1. This transponder 100 comprises an electronic chip 120 fastened to a carrier or PCB (printed circuit board) 102 and galvanically connected, via conductive tracks 104, and soldered joints 130, to two half-antennas 110 and 112. The antennas are helical springs the core of which is steel wire. The electronic portion and at least part of the antennas are embedded in an insulating rubber compound 150. The antennas define an axis of symmetry 39.

The radiofrequency transponder 30 of the communication module 20 such as shown in FIG. 4 corresponds to a second embodiment of the communication module 20 that will now be described.

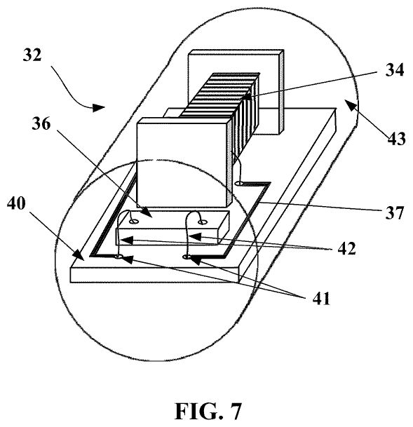

The radiofrequency transponder 30 according to this second embodiment of the communication module 20 comprises an electronic portion 32 and a radiating antenna 31 able to communicate with an external radiofrequency reader. It additionally comprises (see FIG. 7) a primary antenna 34 electrically connected to the electronic chip 36 and inductively coupled to the radiating antenna 31. The radiating antenna is a dipole antenna consisting of a single-strand helical spring defining a first longitudinal axis.

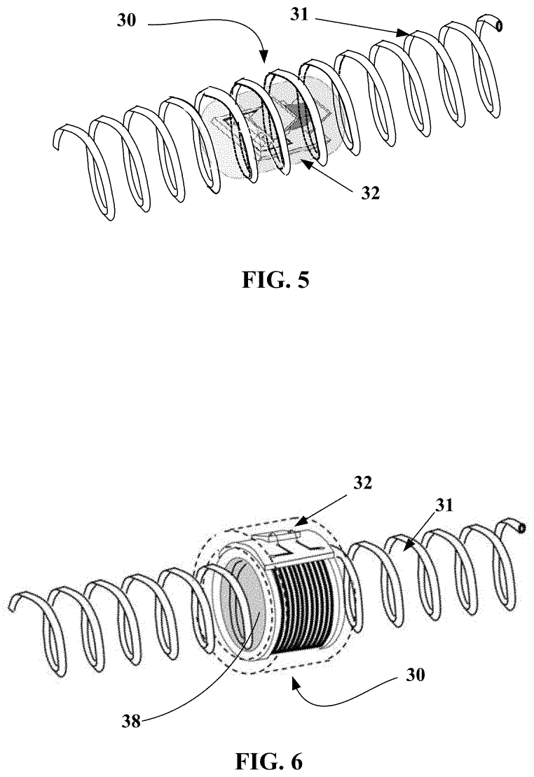

FIG. 5 shows a radiofrequency transponder 30 in a configuration in which the electronic portion 32 is located in the interior of the radiating antenna 31. The geometric shape of the electronic portion 32 is circumscribed by a cylinder the diameter of which is smaller than or equal to the inside diameter of the helical spring. This makes it easier for the electronic portion 32 to be inserted into the radiating antenna 31. The median plane of the primary antenna is located in the central region of the radiating antenna and substantially superposed on the median plane of the radiating antenna.

FIG. 6 shows a radiofrequency transponder 30 in a configuration in which the electronic portion 32 is located outside the radiating antenna 31. The geometric shape of the electronic portion 32 has a cylindrical cavity 38 the diameter of which is larger than or equal to the outside diameter of the radiating antenna 31. This makes it easier for the radiating antenna 31 to be inserted into the cylindrical cavity 38 of the electronic portion. The median plane of the primary antenna is located in the central region of the radiating antenna and substantially in the median plane of the radiating antenna 31.

FIG. 7 shows the electronic portion 32 of a radiofrequency transponder 30 intended for a configuration in which the electronic portion 32 is located inside the radiating antenna 31. The electronic portion 32 comprises an electronic chip 36 and a primary antenna 34 that is electrically connected to the electronic chip 36 via a printed circuit board 40. The primary antenna here consists of a surface-mount-device (SMD) microcoil. The components on the printed circuit board are electrically connected using copper tracks 37 terminated by copper pads 41. The components on the printed circuit board are electrically connected using the wire-bonding technique by gold wires 42 between the component and the pads 41. The assembly consisting of the printed circuit board 40, of the electronic chip 36 and of the primary antenna 34 is embedded in a rigid mass 43 made of electrically insulating high-temperature epoxy resin forming the electronic portion 32 of the radiofrequency transponder 30.

This radiofrequency transponder 30 has the advantage of being mechanically far stronger than the conventional transponders.

1.-20. (canceled)

21. A tire intended to be mounted on a drop-center rim, the tire comprising a radial carcass reinforcement, made up of a single carcass reinforcement layer formed of reinforcing elements inserted between two skim layers of rubber compound, the tire comprising a crown reinforcement, itself radially capped by a tread, the tread being connected to two beads by two sidewalls, the layer of reinforcing elements of the carcass reinforcement being anchored in each of the beads by being turned up around a bead wire to form a main part of the carcass reinforcement layer, extending from one bead wire to the other, and a turn-up of the carcass reinforcement layer in each of the beads, the turn-up of the carcass reinforcement layer being separated from the main part of the carcass reinforcement layer by a first layer of rubber compound extending radially from the bead wire to beyond an end of the turn-up of the carcass reinforcement layer, and the turn-up of the carcass reinforcement layer being, axially toward an outside, in contact with a second layer of rubber compound, itself at least in contact with a third layer of rubber compound that forms an exterior surface of the tire in the region of the bead, the third layer of rubber compound being configured to come into contact with the rim, the third layer of rubber compound being, radially toward the outside, in contact with a fourth layer of rubber compound that forms an exterior surface of the sidewall,
wherein, in a meridian section of the tire, the distance d_{R} between the end of the turn-up of the carcass reinforcement layer and a radially innermost point of a circle circumscribed on the bead wire is between 45 and 90% of the distance d_{E} between an axially outermost point of the main part of the carcass reinforcement layer and the radially innermost point of the circle circumscribed on the bead wire,
wherein, in a meridian section of the tire, the turn-up of the carcass reinforcement layer and the main part of the carcass reinforcement layer are the only layers of reinforcing elements of which an elongation at break is less than 6% that are present in a sidewall region making up at least 90% of the region comprised between the end of the turn-up of the carcass reinforcement layer and a radially outermost point of the bead wire, and
wherein, in a meridian section, the radiofrequency communication module is positioned in the bead at the interface between the turn-up of the carcass reinforcement layer and the second layer of rubber compound.

22. The tire according to claim 21, wherein, with the first layer of rubber compound being profiled, the turn-up of the carcass reinforcement layer and the main part of the carcass reinforcement layer are coupled radially toward the outside starting from a point C on the turn-up of the carcass reinforcement layer, which point is situated at a distance between 30 and 55% of the distance d_{R}, and wherein the radiofrequency communication module is positioned radially on the outside beyond the point C.

23. The tire according to claim 22, wherein, radially toward the outside, starting from the point C of the turn-up of the carcass reinforcement layer, the turn-up of the carcass reinforcement layer and the main part of the carcass reinforcement layer are coupled along a length of between 15 and 65% of the distance d_{R}, and are then decoupled by the first layer of rubber compound as far as the end of the turn-up of the carcass reinforcement layer, and wherein the radiofrequency communication module is placed radially facing the region of coupling between the turn-up and the main part of the carcass reinforcement.

24. The tire according to claim 23, wherein the decoupling length is between 5 and 40% of the distance d_{R}.

25. The tire according to claim 21, wherein the turn-up of the carcass reinforcement layer and the main part of the carcass reinforcement layer are coupled along a length of between 25 and 40% of the distance d_{R}.

26. The tire according to claim 22, wherein, in the coupling region, a thickness of the first layer of rubber compound is substantially constant and between 0.8 and 5 mm.

27. The tire according to claim 21, wherein a radially inner end of the second layer of rubber compound is radially comprised between the radially outermost point B of the circle circumscribed on the bead wire and the radially innermost point A of the circle circumscribed on the bead wire.

28. The tire according to claim 21, wherein a tensile elastic modulus at 10% elongation of the skim layers of the carcass reinforcement layer is between 4 and 16 MPa.

29. The tire according to claim 21, wherein a tensile elastic modulus at 10% elongation of the first layer of rubber compound is less than or equal to a tensile elastic modulus at 10% elongation of the skim rubber of the carcass reinforcement layer.

30. The tire according to claim 21, wherein a tensile elastic modulus at 10% elongation of the first layer of rubber compound is greater than 50% of a tensile elastic modulus at 10% elongation of the skim rubber of the carcass reinforcement layer.

31. The tire according to claim 21, wherein a tensile elastic modulus at 10% elongation of the second layer of rubber compound is less than 150% of a tensile elastic modulus at 10% elongation of the skim rubber of the carcass reinforcement layer.

32. The tire according to claim 21, wherein the communication module consists of a radiofrequency transponder encapsulated in an electrically insulating encapsulating rubber mass.

33. The tire according to claim 32, wherein the radiofrequency transponder is sandwiched between two sheets of rubber.

34. The tire according to claim 32, wherein an elastic modulus of the electrically insulating encapsulating rubber mass is lower than or equal to an elastic modulus of adjacent rubber compounds.

35. The tire according to claim 32, wherein a relative dielectric constant of the electrically insulating encapsulating rubber mass is lower than a relative dielectric constant of adjacent rubber compounds.

36. The tire according to claim 32, wherein the radiofrequency transponder further comprises a helical radiating antenna which defines a first longitudinal axis, and the first longitudinal axis is oriented circumferentially.

37. The tire according to claim 36, wherein, with the helical radiating antenna comprising two helical antenna segments, an electronic chip is galvanically connected to the two helical antenna segments.

38. The tire according to claim 37, wherein the radiofrequency transponder additionally comprises a primary antenna electrically connected to the electronic chip, wherein the primary antenna is inductively coupled to the helical radiating antenna, and wherein the helical radiating antenna is a dipole antenna consisting of a single-strand helical spring defining the first longitudinal axis.

39. The tire according to claim 38, wherein the primary antenna is a coil having at least one turn defining a second longitudinal axis that is circumscribed in a cylinder the axis of revolution of which is parallel to the second longitudinal axis and the diameter of which is between one third and three times an average diameter of the helical spring of the helical radiating antenna.

40. The tire according to claim 38, wherein the primary antenna is placed inside the single-strand helical spring of the helical radiating antenna.
